(19) United States
(12) Patent Application Publication
(10) Pub. No.: US 2003/0141632 A1
(43) Pub. Date: Jul. 31, 2003

(54) Adjusting system for a die

(76) Inventors: Klaus Fuller, Schwerin (DE); Lothar Elsner, Pampow (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/321,279

(22) Filed: Dec. 16, 2002

(30) Foreign Application Priority Data
Dec. 17, 2001 (DE) 101 61 911.1

(51) Int. Cl. B29C 45/64

(52) U.S. Cl. 264/328.1; 425/589; 425/595; 425/542; 425/450.1

(57) ABSTRACT

An injection-molding die, which comprises a movable die platen guided via crossbeams is provided, wherein an adjusting element is positively connected to each crossbeam and can be adjusted axially relative to the crossbeam via a central drive and the position of the die platen changes relative to the crossbeams. An apparatus and method is provided in which at least one of the adjusting elements can be locked against an axial movement and against rotation by means of a fixing device. The fixing device may be a piston element in a closure cover arranged on the movable die platen.

### RELATED APPLICATION

This application Claims priority under 35 U.S.C. § 119 or 365 to German Application No. 101 61 911.1, filed Dec. 17, 2001, the entire teachings of which are incorporated herein by reference.

### BACKGROUND OF THE INVENTION

Installation height adjustments for injection-molding dies of the generic type are generally known. Hence, for example, European Patent Application 1 88 000 describes a device in which the movable die support plate is displaced via a central drive motor by means of a connecting member, which is arranged between the die support plate and the closing piston, and hence the total stroke may be changed.

### SUMMARY OF THE INVENTION

One disadvantage of known injection-molding devices is that the system-related play, which is produced by the sum of the tolerances in the individual components and is necessary for the movement of the components, facilitates a relative movement to the crossbeams corresponding to the axial play even after adjusting the installation height.

One aspect of the invention is to offer a device and a process that makes it possible to eliminate as far as possible the relative movement between the movable die platen and the crossbeams, which can also be referred to as tie beams or columns.

One embodiment of the invention provides that at least one of the adjusting elements can be locked against an axial movement and against rotation by a fixing device. It thus becomes possible to compensate existing play between the components and consequently to fix the adjustment of the die platen carried out in this position.

The fixing device can include a displaceable piston which can be actuated hydraulically, pneumatically, or mechanically. It is ensured in all cases that the adjusting element is clamped and thus fixed between a closure cover and the movable die platen.

By way of advance, provision is made to couple the control of the fixing device, that is, activation, for example, of the piston by exposure to a hydraulic or pneumatic pressure or rotation of a threaded spindle with the control of a machine.

After axial adjustment, the position of the adjusting element can be fixed by actuating a fixing device. At best, fixing of the adjusting element is achieved in that the adjusting element is fixed between the movable die platen and a closure cover arranged on the latter via the fixing device. In the axial direction, fixing of the adjusting element takes place non-positively with frictional engagement of the adjusting element against rotation. The adjusting device is clamped, in that the fixing device, which can be triggered via the machine control, is exposed to a pressure. The pressure may thus be built up hydraulically or pneumatically. A mechanical solution can also be used; here, in particular, a threaded spindle is intended.

### BRIEF DESCRIPTION OF THE DRAWINGS

The foregoing and other objects, features and advantages of the invention will be apparent from the following more particular description of various embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows schematically an injection-molding machine;

FIG. 2 illustrates a section through a region of the adjusting system; and

FIG. 3 illustrates a view of the drive of an embodiment of the adjusting system.

### DETAILED DESCRIPTION OF THE INVENTION

A description of embodiments of the invention follows.

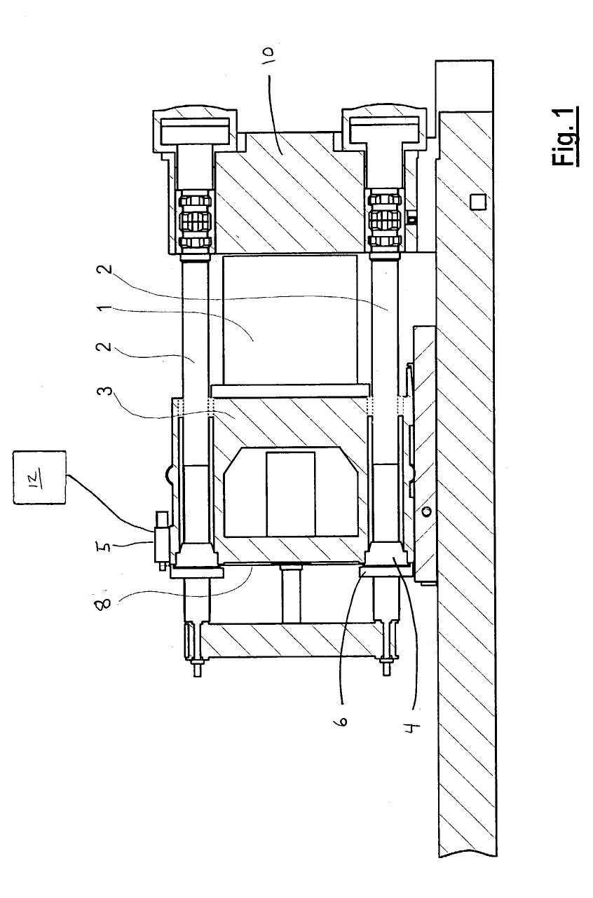

FIG. 1 shows an injection-molding machine in which a die 1 is taken up between one fixed die platen 10 and one movable die platen 3. The movable die platen 3 is guided via crossbeams 2, which can also be referred to as tie beams or columns. Since different die heights are used, it is necessary to be able to adapt the installation height individually to the particular requirements. Thus, one aspect of the present application is to change the position of the movable die platen 3 relative to the crossbeams 2.

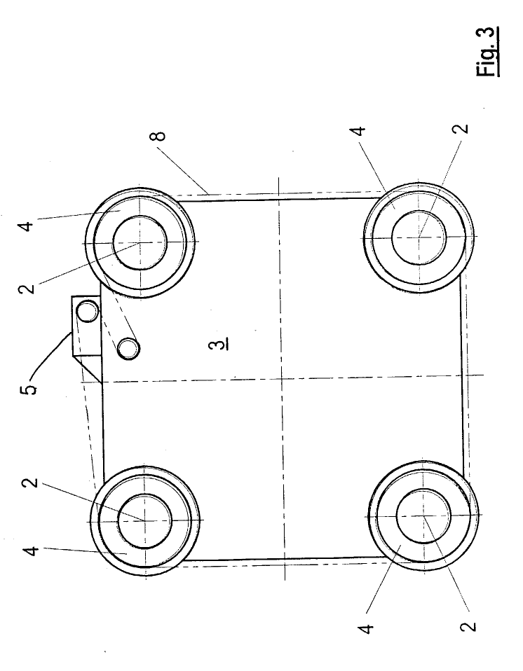

A corresponding adjusting system 4 is connected, in one embodiment, to each crossbeam 2 via a thread 9. By rotating the adjusting system 4, the latter is displaced axially on the crossbeam 2. Since control takes place centrally, a chain 8 (FIG. 3) embracing all adjusting systems 4 usually ensures that all adjusting systems 4 are rotated about the same angle, and consequently twisting does not take place. The adjusting system 4 is connected to the movable die platen 3 and drives the latter.

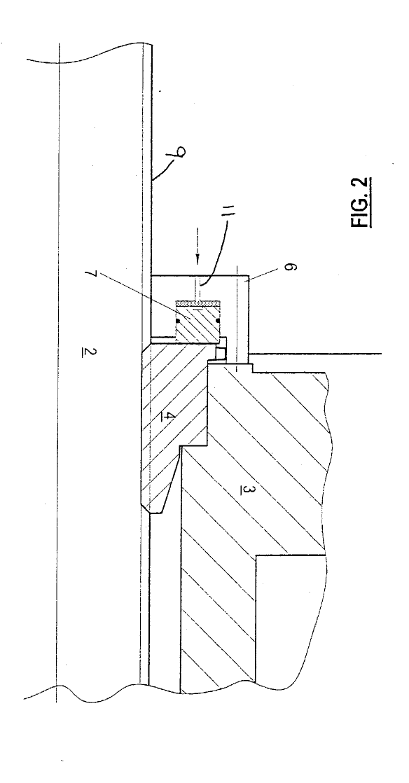

FIG. 2 illustrates above the centerline of a crossbeam 2 how the adjusting system 4 changes the relative position of the movable die platen 3. The adjusting system 4 is connected to the crossbeam 2 via a thread 9. By rotating the adjusting system 4, the latter is moved axially on the crossbeam 2 and comes to rest either on the movable die platen 3 or the fixing device piston 7. Since the fixing device 7 is also connected to the movable die platen 3 via the closure cover 6, when the adjusting system 4 rotates, the position of the movable die platen 3 also necessarily changes. In order to fix this new position of the movable die platen 3, the adjusting device 4 is pressed against the movable die platen 3 and is clamped by fixing device 7 to prevent rotation and thus further axial movement of the adjusting device 4. Fixing device 7 may be pressed against the adjusting device 4 by injection of fluid pressure through the port 11, either hydraulically or pneumatically. Alternatively, the fixing device piston 7 may be driven mechanically. In any case, it may be actuated from a central machine control system 12.

The central adjustment can be seen from FIG. 3. A central drive 5 is connected to the particular adjusting elements 4 arranged on the crossbeams 2 via a chain 8. All adjusting elements 4 are actuated via the drive 5. This ensures that all adjusting elements 4 are subjected to the same angular change and consequently for the same thread pitch in the connection between adjusting element 4 and crossbeam 2, which is required to also execute the same stroke relative to the crossbeam 2.

The adjusting system of the present application can be used with an injection molding machine disclosed in U.S. patent application Ser. No. 10/044,292, filed on Jan. 11, 2002, the entire teachings of which are incorporated herein by reference.

While this invention has been particularly shown and described with references to embodiments thereof, it will be understood by those skilled in the art that various changes in form and details may be made therein without departing from the scope of the invention encompassed by the appended Claims.

What is claimed is:

1. A device for adjusting the installation height of an injection-molding die, comprising a movable die platen guided via crossbeams, an adjusting element being positively connected to each crossbeam and being adjustable axially relative to the crossbeam via a central drive, the position of the die platen being changeable relative to the crossbeams, at least one of the adjusting elements being lockable against an axial movement and against rotation by a fixing device.

2. The device according to claim 1, wherein the fixing device includes a displaceable piston.

3. The device according to claim 2, wherein the piston is actuated hydraulically.

4. The device according to claim 2, wherein the piston is actuated pneumatically.

5. The device according to claim 2, wherein the piston is actuated mechanically.

6. The device according to claim 1, wherein actuation of the fixing device is controlled via machine control.

7. The device according to claim 1, further comprising a closure cover arranged on the movable die platen.

8. A process for adjusting a height of an injection-molding die, in which a movable die platen is guided via crossbeams and its position relative to the crossbeams can be changed via adjusting elements, the adjusting elements being connectable positively to the crossbeams and rotatable via a central drive around the latter, as a result of which axial adjustment of the relative position to the crossbeams takes place, the position of the adjusting element being fixable by actuating a fixing device, the method including adjusting the position of the movable die platen relative to the crossbeams.

9. The process according to claim 8, wherein fixing of the adjusting element takes place in that the adjusting element is fixed non-positively between the movable die platen and a closure cover arranged on the latter via the fixing device.

10. The process according to claim 9, wherein the fixing device is actuated by applying a pressure to the fixing device.

11. The process according to claim 10, wherein the pressure application takes place at least one of hydraulically or pneumatically.

12. The process according to claim 9, wherein the fixing device takes place mechanically.

13. The process according to claim 12, wherein the fixing device takes place by rotating a threaded spindle.

14. An injection-molding machine, comprising:
an injection-molding die including a movable die platen guided by a plurality of tie bars;
at least one adjusting element that adjusts a distance between the die platen and the plurality of tie bars, the at least one adjusting element being movable along a longitudinal axis of a tie bar;
a drive that actuates the at least one adjusting element to cause movement between the at least one adjusting element and the tie bar; and
a fixing device that locks the at least one adjusting element in place to prevent movement between the at least one adjusting element and the tie bar.

15. The injection-molding machine of claim 14, further comprising three additional adjusting elements, each axially movable on an associated tie bar.

16. The injection-molding machine of claim 14, wherein the at least one adjusting element is rotatable about the tie bar to cause movement between the at least one adjusting element and the tie bar.

17. The injection-molding machine of claim 14, wherein the fixing device includes a piston.

18. The injection-molding machine of claim 17, wherein the piston can be actuated hydraulically, pneumatically, and/or mechanically.

19. A method for operating an injection-molding machine that includes a movable die platen guided by a plurality of tie bars, and at least one adjusting element for adjusting a distance between the die platen and at least one of the plurality of tie bars, comprising:
actuating the at least one adjusting element to cause movement between the at least one adjusting element and the at least one of the plurality of tie bars; and
locking the at least one adjusting element in place to prevent movement between the at least one adjusting element and the tie bar.

20. The method of claim 19, further comprising simultaneously actuating at least four adjusting elements to cause movement between the at least four adjusting elements and associated tie bars.

21. The method of claim 19, further comprising locking the adjusting element with a displaceable piston.
